(19) United States
(12) Patent Application Publication
(10) Pub. No.: US 2026/0180618 A1
(43) Pub. Date: Jun. 25, 2026

(54) UWB ELECTRONIC DEVICE AND METHOD OF OPERATING THEREOF

(71) Applicant: Samsung Electronics Co., Ltd., Suwon-si (KR)

(72) Inventors: Eunhye PARK, Suwon-si (KR); Hoon KANG, Suwon-si (KR); Jaegook LEE, Suwon-si (KR); Youngmin JEON, Suwon-si (KR)

(73) Assignee: Samsung Electronics Co., Ltd., Suwon-si (KR)

(21) Appl. No.: 19/419,685

(22) Filed: Dec. 15, 2025

(30) Foreign Application Priority Data
Dec. 19, 2024 (KR) 10-2024-0191722

(51) Int. Cl. H04B 1/7093; H04B 1/7163

(52) U.S. Cl. CPC H04B 1/7093; H04B 1/7163

(57) ABSTRACT

Disclosed is a method of operating an Ultra Wide Band (UWB) device, which includes receiving a plurality of receive signals from an external device, each of the plurality of receive signals including a plurality of code symbols, accumulating a subset of receive signals among the plurality of receive signals to generate accumulation samples, performing first matched filtering on all code symbols among the accumulation, performing second matched filtering on a subset of code symbols among the accumulation samples, estimating a boundary code symbol based on the first matched filtering result, and estimating a first number and a Carrier Frequency Offset (CFO) based on the boundary code symbol, the first matched filtering result and the second matched filtering result to obtain an estimated first number and an estimated CFO, the first number being a number of receive signals from among the plurality of receive signals including only idle code symbols.

### CROSS-REFERENCE TO RELATED APPLICATIONS

This application claims priority under 35 U.S.C. § 119 to Korean Patent Application No. 10-2024-0191722 filed on Dec. 19, 2024, in the Korean Intellectual Property Office, the disclosures of which are incorporated by reference herein in their entireties.

### BACKGROUND

Embodiments of the present disclosure described herein relate to an electronic device, and more particularly, relate to a UWB electronic device and a method operating thereof.

UWB (Ultra Wide Band) systems may communicate through UWB signals. The UWB signals may have a wider frequency band, lower spectral density, and a shorter pulse width (e.g., 1 to 4 nanoseconds).

The UWB systems may repeatedly transmit and receive the UWB signals to perform ranging between UWB devices. In this case, when a UWB device of a UWB system is in an idle state, the reception time of the UWB signals may be unclear. When the reception time of the UWB signals is unclear, the communication performance of the UWB systems may be reduced.

### SUMMARY

Embodiments of the present disclosure provide a UWB electronic device and a method of operating the same having improved performance, improved reliability, and improved safety.

According to embodiments of the present disclosure, a method of operating an Ultra Wide Band (UWB) device includes receiving a plurality of receive signals from an external device, each of the plurality of receive signals including a plurality of code symbols, accumulating a subset of receive signals among the plurality of receive signals to generate accumulation samples, performing first matched filtering on all code symbols among the accumulation samples to obtain a first matched filtering result, performing second matched filtering on a subset of code symbols among the accumulation samples to obtain a second matched filtering result, estimating a boundary code symbol based on the first matched filtering result, and estimating a first number and a Carrier Frequency Offset (CFO) based on the boundary code symbol, the first matched filtering result and the second matched filtering result to obtain an estimated first number and an estimated CFO, the first number being a number of receive signals from among the plurality of receive signals including only idle code symbols.

According to embodiments of the present disclosure, an Ultra Wide Band (UWB) device includes processing circuitry configured to cause the UWB device to receive a plurality of receive signals from an external device, each of the plurality of receive signals including a plurality of code symbols, accumulate a subset of receive signals among the plurality of receive signals to generate accumulation samples, perform first matched filtering on all code symbols among the accumulation samples to obtain a first matched filtering result, perform second matched filtering on a subset of code symbols among the accumulation samples to obtain a second matched filtering result, estimate a boundary code symbol based on the first matched filtering result, and estimate a first number and a Carrier Frequency Offset (CFO) based on the boundary code symbol, the first matched filtering result and the second matched filtering result to obtain an estimated first number and an estimated CFO, the first number being a number of receive signals from among the plurality of receive signals including only idle code symbols.

According to embodiments of the present disclosure, an Ultra Wide Band (UWB) communication system includes a transmitter configured to transmit a plurality of transmit signals to an external UWB device, each of the plurality of transmit signals including a plurality of first code symbols, and processing circuitry configured to cause the UWB communication system to receive a plurality of receive signals from the external UWB device, each of the plurality of receive signals including a plurality of second code symbols, accumulate a subset of receive signals among the plurality of receive signals to generate accumulation samples, perform first matched filtering on all second code symbols among the accumulation samples to obtain a first matched filtering result, perform second matched filtering on a subset of second code symbols among the accumulation samples to obtain a second matched filtering result, estimate a boundary code symbol based on the first matched filtering result, and estimate a first number and a Carrier Frequency Offset (CFO) based on the boundary code symbol, the first matched filtering result and the second matched filtering result, the first number being a number of receive signals from among the plurality of receive signals including only idle code symbols.

According to embodiments of the present disclosure, a non-transitory computer-readable medium stores instructions that, when executed by processing circuitry of an Ultra Wide Band (UWB) device, cause the processing circuitry to perform a method including receiving a plurality of receive signals from an external device, each of the plurality of receive signals including a plurality of code symbols, accumulating a subset of receive signals among the plurality of receive signals to generate accumulation samples, performing first matched filtering on all code symbols among the accumulation samples to obtain a first matched filtering result, performing second matched filtering on a subset of code symbols among the accumulation samples to obtain a second matched filtering result, estimating a boundary code symbol based on the first matched filtering result, and estimating a first number and a Carrier Frequency Offset (CFO) based on the boundary code symbol, the first matched filtering result and the second matched filtering result to obtain an estimated first number and an estimated CFO, the first number being a number of receive signals from among the plurality of receive signals including only idle code symbols.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a communication system, according to embodiments of the present disclosure.

FIG. 2 is a diagram for describing a UWB signal in more detail.

FIG. 3 is a diagram illustrating an MMRS symbol of FIG. 2 in more detail.

FIG. 4 is a diagram illustrating a first UWB device of FIG. 1 in more detail.

FIG. 5A and FIG. 5B are diagrams for describing a transmit signal transmitted by a UWB device and a receive signal received by a UWB device.

FIGS. 6A and 6B are diagrams for describing an operation of a symbol accumulator.

FIG. 7 is a drawing for describing a matched filtering operation of a match filter.

FIGS. 8A, 8B, and 8C are diagrams for describing an operation of an idle CFO estimator.

FIG. 9 is a flowchart illustrating an operation method of a UWB device, according to embodiments of the present disclosure.

FIG. 10 is a flowchart describing in more detail an operation method of a UWB device, according to embodiments of the present disclosure.

FIGS. 11A and 11B are diagrams for describing the number of idle samples and a CFO.

### DETAILED DESCRIPTION

Hereinafter, embodiments of the present disclosure may be described in detail and clearly to such an extent that an ordinary one in the art may easily implement the present disclosure.

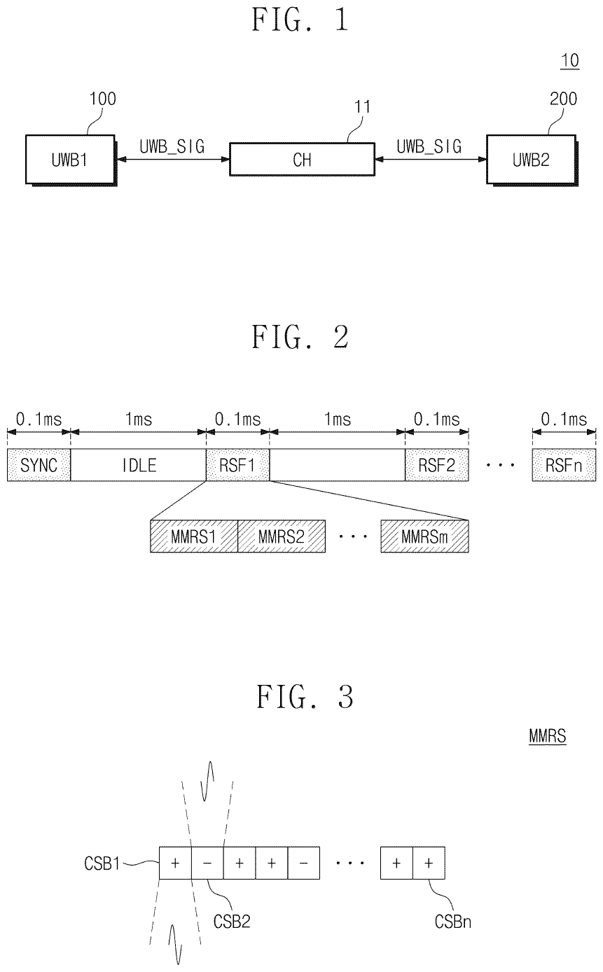

FIG. 1 is a block diagram illustrating a communication system, according to embodiments of the present disclosure.

Referring to FIG. 1, a communication system 10 may include a first UWB device 100 (UWB1), a second UWB device 200 (UWB2), and/or a channel 11 (CH). The communication system 10 may be a system that uses Ultra Wide Band (UWB) communication. For example, the communication system 10 may communicate using a UWB signal UWB_SIG. The UWB signal may have a wider frequency band, lower spectral density, and a shorter pulse width (e.g., 1 to 4 nanoseconds). The communication system 10 may perform ranging between the UWB devices 100 and 200 using the UWB signal UWB_SIG. For example, the communication system 10 may measure the distance between the UWB devices 100 and 200 using the UWB signal UWB_SIG.

The first UWB device 100 and the second UWB device 200 may communicate using the UWB signal UWB_SIG. The first UWB device 100 and the second UWB device 200 may communicate through the channel 11. For example, the first UWB device 100 may transmit the UWB signal UWB_SIG to the second UWB device 200 through the channel 11. Alternatively or additionally, the first UWB device 100 may receive the UWB signal UWB_SIG from the second UWB device 200 through the channel 11.

In embodiments, the first UWB device 100 and the second UWB device 200 may repeatedly transmit or receive the plurality of UWB signals UWB_SIG. For example, the first UWB device 100 and the second UWB device 200 may repeatedly transmit or receive the plurality of UWB signals UWB_SIG to perform ranging between the UWB devices 100 and 200. Each of the plurality of UWB signals UWB_SIG for ranging between the UWB devices 100 and 200 may be the same signal (or similar signals). The time interval at which the plurality of UWB signals UWB_SIG are transmitted and received may be uniform (or similar).

In embodiments, the channel 11 may add noise to the plurality of UWB signals UWB_SIG. For example, when the second UWB device 200 transmits the UWB signal UWB_SIG to the first UWB device 100 through the channel 11, noise may be added to the UWB signal UWB_SIG. Due to the noise, the first UWB device 100 and the second UWB device 200 may be interrupted from receiving the plurality of UWB signals UWB_SIG. For example, due to the noise, the first UWB device 100 and the second UWB device 200 may be interrupted from ranging between the UWB devices 100 and 200.

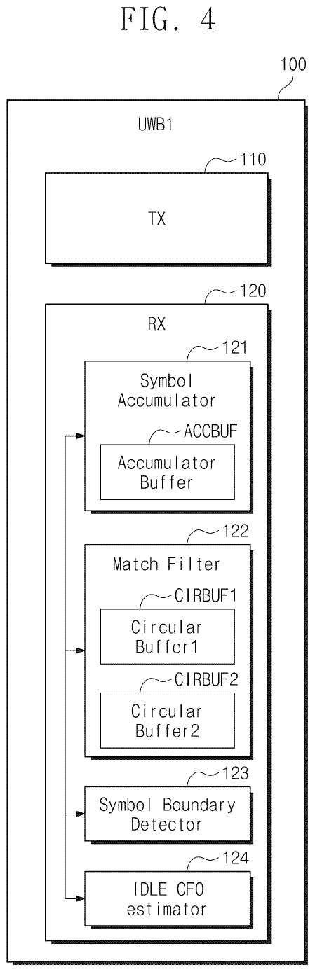

FIG. 2 is a diagram for describing a UWB signal in more detail.

Referring to FIGS. 1 and 2, the UWB signal UWB_SIG is illustrated.

The first UWB device 100 may transmit or receive the UWB signal UWB_SIG. For example, the first UWB device 100 may transmit or receive the UWB signal UWB_SIG to/from the second UWB device 200 through the channel 11.

In embodiments, the UWB signal UWB_SIG may include a SYNC signal SYNC and RSF (Ranging Sequence Fragment) signals RSF1 to RSFn. The UWB signal UWB_SIG may have a shorter pulse. For example, the pulse of the SYNC signal SYNC and the pulse of the RSF signals RSF1 to RSFn may be 0.1 ms, but the scope of the present disclosure is not limited thereto.

The SYNC signal SYNC may be a signal for synchronizing the UWB devices 100 and 200. The UWB devices 100 and 200 may perform synchronization between the UWB devices 100 and 200 based on the SYNC signal SYNC. For example, when the second UWB device 200 transmits the SYNC signal SYNC to the first UWB device 100, the first UWB device 100 may synchronize with the second UWB device 200 based on the SYNC signal SYNC. For example, a receiver (not illustrated) of the first UWB device 100 may perform time synchronization and/or frequency synchronization based on the SYNC signal SYNC.

The RSF signals RSF1 to RSFn may be signals for ranging between the UWB devices 100 and 200. For example, the UWB devices 100 and 200 may perform ranging between the UWB devices 100 and 200 based on the RSF signals RSF1 to RSFn. For example, the second UWB device 200 may transmit the RSF signals RSF1 to RSFn to the first UWB device 100, and the first UWB device 100 may perform ranging between the UWB devices 100 and 200 based on the received RSF signals RSF1 to RSFn. By performing the ranging, the first UWB device 100 may measure the distance between the first UWB device 100 and the second UWB device 200.

In embodiments, each of the RSF signals RSF1 to RSFn may be the same signal (or similar signals). For example, the second UWB device 200 may transmit the same RSF signals RSF1 to RSFn, or similar RSF signals RSF1 to RSFn, (e.g., the same or similar with respect to each other) to the first UWB device 100, and the first UWB device 100 may receive the same RSF signals RSF1 to RSFn, or similar RSF signals RSF1 to RSFn, (e.g., the same or similar with respect to each other). The first UWB device 100 may perform ranging based on the same RSF signals RSF1 to RSFn (or similar RSF signals RSF1 to RSFn).

In embodiments, each of the RSF signals RSF1 to RSFn may be transmitted at a uniform period (or similar periods). For example, each of the RSF signals RSF1 to RSFn may be transmitted at a period of 1 ms, but the scope of the present disclosure is not limited thereto.

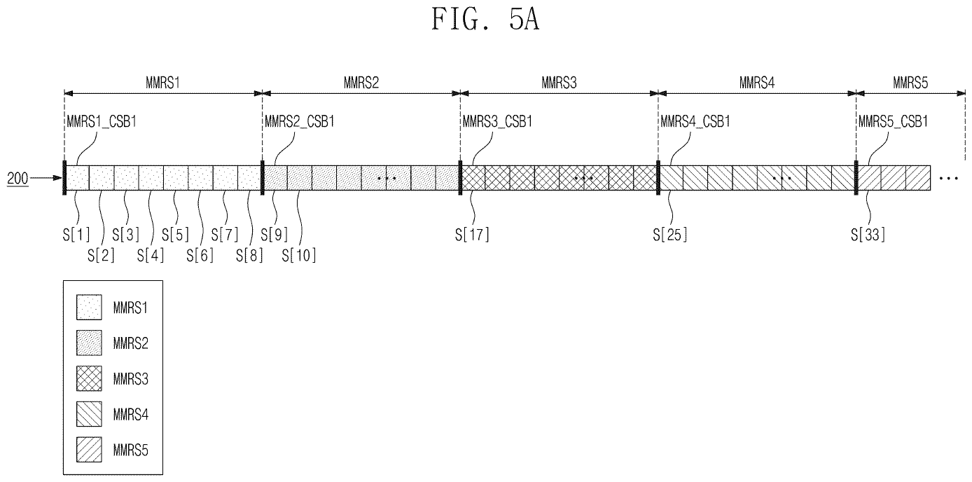

In embodiments, each of the RSF signals RSF1 to RSFn may include a plurality of MMRS (Multi Mili Ranging Symbol) symbols MMRS1 to MMRSm. For example, each of the RSF signals RSF1 to RSFn may represent a signal based on a combination of the plurality of MMRS symbols MMRS1 to MMRSm. For example, the RSF signals RSF1 to RSFn may represent a signal for ranging between the UWB devices 100 and 200 based on a combination of the plurality of MMRS symbols MMRS1 to MMRSm. The MMRS symbols will be described in more detail with reference to FIG. 3.

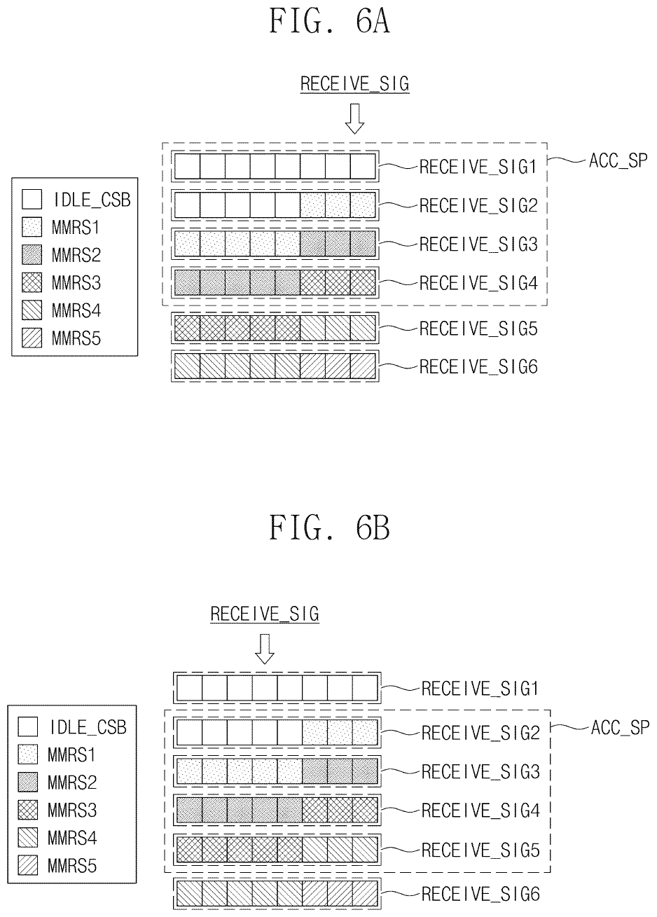

In embodiments, the first RSF signal RSF1 among the RSF signals RSF1 to RSFn may be received after a relatively long time from the reception time of the SYNC signal SYNC. For example, after the first UWB device 100 performs synchronization based on the SYNC signal SYNC, the first UWB device 100 may have an idle period IDLE. The idle period IDLE may be 1 ms, but the scope of the present disclosure is not limited thereto. Since the first UWB device 100 has the idle period IDLE, it is necessary (or otherwise, desirable) to measure the time at which the first RSF signal RSF1 among the RSF signals RSF1 to RSFn is received. By measuring the time at which the first RSF signal RSF1 is received, ranging between the UWB devices 100 and 200 may be accurately performed. The operation of measuring the first RSF signal RSF1 will be described later with reference to FIGS. 5A to 9, etc.

FIG. 3 is a diagram illustrating an MMRS symbol of FIG. 2 in more detail.

Referring to FIG. 3, an MMRS symbol MMRS may include a plurality of code symbols CSB1 to CSBn. The MMRS symbol MMRS may represent a signal based on a combination of the plurality of code symbols CSB1 to CSBn. The MMRS symbol MMRS may have “n” code symbols. According to embodiments, the MMRS symbol MMRS may represent each among the plurality of MMRS symbols MMRS1 to MMRSm.

In embodiments, the MMRS symbol MMRS may have a code unit or a symbol unit. For example, when the MMRS symbol MMRS is a 128 code, the MMRS symbol MMRS may have 128 code symbols, and when the MMRS symbol MMRS is a 256 code, the MMRS symbol MMRS may have 256 code symbols, but the scope of the present disclosure is not limited thereto. Hereinafter, for convenience of explanation, the unit of the MMRS symbol MMRS is referred in units of symbols.

Each of the plurality of code symbols CSB1 to CSBn may have a positive phase or a negative phase, and the MMRS symbol MMRS may represent a signal based on a combination of the plurality of code symbols CSB1 to CSBn. For example, the first code symbol CSB1 may have a positive phase, and the second code symbol CSB2 may have a negative phase. The MMRS symbol MMRS may represent a signal based on a combination of the code symbols CSB1 to CSBn having a positive phase or a negative phase. For example, the MMRS symbol may represent a signal for ranging between the UWB devices 100 and 200 based on a combination of the code symbols CSB1 to CSBn having a positive phase or a negative phase.

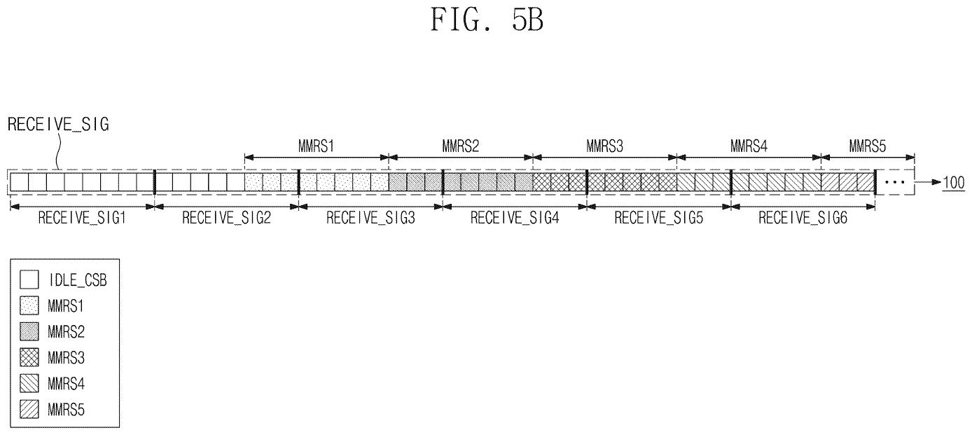

FIG. 4 is a diagram illustrating a first UWB device of FIG. 1 in more detail.

Referring to FIGS. 1 to 4, the first UWB device 100 may include a transmitter 110 and a receiver 120.

The transmitter 110 may transmit the UWB signal UWB_SIG. The UWB signal UWB_SIG may include the SYNC signal SYNC and the RSF signals RSF1 to RSFn. For example, the transmitter 110 of the first UWB device 100 may transmit the UWB signal UWB_SIG to the second UWB device 200.

The receiver 120 may receive the UWB signal UWB_SIG. For example, the receiver 120 of the first UWB device 100 may receive the UWB signal UWB_SIG from the second UWB device 200.

In embodiments, the receiver 120 may include a symbol accumulator 121, a match filter 122, a symbol boundary detector 123, and/or an idle CFO estimator 124. In embodiments, the receiver 120 may measure a reception time of the first RSF signal RSF1 based on the symbol accumulator 121, the match filter 122, the symbol boundary detector 123, and the idle CFO estimator 124. For example, the receiver 120 of the UWB signal UWB_SIG, having the idle period IDLE after the SYNC signal SYNC is received, may measure the reception time of the first RSF signal RSF1 based on the symbol accumulator 121, the match filter 122, the symbol boundary detector 123, and the idle CFO estimator 124.

The symbol accumulator 121 may accumulate the UWB signal UWB_SIG in units of symbols. For example, the symbol accumulator 121 may accumulate the UWB signal UWB_SIG transmitted by the second UWB device 200 in units of symbols. In embodiments, the symbol unit may be the number of code symbols forming the MMRS symbol MMRS. For example, when the MMRS symbol MMRS is composed of 128 code symbols, the symbol unit of the MMRS symbol MMRS may be 128, and the symbol accumulator 121 may accumulate the UWB signal UWB_SIG in 128 symbol units.

In embodiments, the symbol accumulator 121 may include an accumulator buffer ACCBUF. The symbol accumulator 121 may store accumulated accumulation symbols in the accumulator buffer ACCBUF. For example, the symbol accumulator 121 may store the accumulation symbols accumulated in symbol units of the MMRS symbol MMRS in the accumulator buffer ACCBUF. The accumulator buffer ACCBUF may be composed of a register or a Static Random Access Memory (SRAM) device, but the scope of the present disclosure is not limited thereto.

The match filter 122 may perform matched filtering on the UWB signal UWB_SIG. For example, the match filter 122 may perform matched filtering on accumulation symbols accumulated by the symbol accumulator 121. For example, the match filter 122 may perform matched filtering on accumulation symbols stored in the accumulator buffer ACCBUF.

In embodiments, the match filter 122 may perform matched filtering twice on the UWB signal UWB_SIG. For example, the match filter 122 may perform matched filtering twice on accumulation symbols stored in the accumulator buffer ACCBUF. For example, the match filter 122 may perform matched filtering based on all code symbols included in the MMRS symbol MMRS among the accumulation symbols stored in the accumulator buffer ACCBUF (hereinafter, referred to as first matched filtering). The match filter 122 may perform matched filtering based on some of the code symbols included in the MMRS symbol MMRS among the accumulation symbols stored in the accumulator buffer ACCBUF (hereinafter, referred to as second matched filtering). However, the scope of the present disclosure is not limited thereto, and the match filter 122 may perform matched filtering on the UWB signal UWB_SIG at least twice.

In embodiments, the match filter 122 may include a first circular buffer CIRBUF1 and a second circular buffer CIRBUF2. The match filter 122 may perform matched filtering on the UWB signal UWB_SIG so as to store in the first circular buffer CIRBUF1 and the second circular buffer CIRBUF2. For example, the match filter 122 may perform the first matched filtering on the UWB signal UWB_SIG so as to store in the first circular buffer CIRBUF1, and may perform the second matched filtering on the UWB signal UWB_SIG so as to store in the second circular buffer CIRBUF2. Each of the first circular buffer CIRBUF1 and the second circular buffer CIRBUF2 may be configured as a register or a Static Random Access Memory (SRAM) device, but the scope of the present disclosure is not limited thereto.

The symbol boundary detector 123 may estimate a boundary symbol. For example, the boundary symbol may be a code symbol that appears first among a plurality of MMRS symbols that form the first RSF signal RSF1 after the idle period IDLE.

The idle CFO estimator 124 may estimate the number of idle symbols. For example, the idle CFO estimator 124 may estimate the number of idle symbols that form the idle period IDLE. The idle CFO estimator 124 may estimate a CFO (Carrier Frequency Offset). For example, the idle CFO estimator 124 may estimate the CFO that represents a frequency difference between the transmitter of the second UWB device 200 and the receiver 120 of the first UWB device 100. The receiver 120 may improve the communication performance based on the number of idle symbols and the CFO. For example, the receiver 120 may perform ranging more accurately based on the number of idle symbols and the CFO.

FIG. 5A and FIG. 5B are diagrams for describing a transmit signal transmitted by a UWB device and a receive signal received by a UWB device. In this case, the first UWB device 100 is described as being in an idle state after receiving the SYNC signal SYNC from the second UWB device 200.

First, referring to FIGS. 1 to 5A, a transmit signal transmitted by the second UWB device 200 is illustrated.

In embodiments, the second UWB device 200 may transmit the plurality of MMRS symbols MMRS1 to MMRS5 to the first UWB device 100. For example, the second UWB device 200 may transmit the plurality of MMRS symbols MMRS1 to MMRS5 included in the RSF signal to the first UWB device 100.

In embodiments, the symbol unit of the MMRS symbols MMRS1 to MMRS5 may be 8. For example, each MMRS symbol among the MMRS symbols MMRS1 to MMRS5 may include 8 code symbols.

In embodiments, the code symbols included in the MMRS symbols MMRS1 to MMRS5 may be expressed based on Equation 1.

$$s [ k ] = {s}_{ref} [ k \% {N}_{samp} ] \qquad [ Equation 1 ]$$

Here, Nₛₐₘₚ may be a symbol unit of the MMRS symbols MMRS1 to MMRS5. For example, referring to FIG. 5A, since the symbol unit of the MMRS symbols MMRS1 to MMRS5 is 8, Nₛₐₘₚ may be 8.

In embodiments, s[k] may represent the code symbol. For example, when k is 1 to 8, it may represent code symbols for the first MMRS symbol MMRS1, and when k is 9 to 16, it may represent code symbols for the second MMRS symbol MMRS2.

In embodiments, S_{ref}[k % Nₛₐₘₚ] may represent a code symbol for one MMRS symbol. For example, each of the MMRS symbols MMRS1 to MMRS5 may be the same (or similar). For example, each of the MMRS symbols MMRS1 to MMRS5 may be a combination of the same code symbols (or similar code symbols). For example, a first code symbol MMRS1_CSB1 of the first MMRS symbol MMRS1 may be the same as (or similar to) a first code symbol MMRS2_CSB1 of the second MMRS symbol MMRS2, a first code symbol MMRS3 CSB1 of the third MMRS symbol MMRS3, a first code symbol MMRS4_CSB1 of the fourth MMRS symbol MMRS4, and a first code symbol MMRS5_CSB1 of the fifth MMRS symbol MMRS5, and S_{ref}[k % Nₛₐₘₚ] may represent a code symbol for one of these MMRS symbols.

Next, referring to FIGS. 1 to 5B, a receive signal received by the first UWB device 100 is illustrated.

The first UWB device 100 may receive a transmit signal transmitted by the second UWB device 200 (or a receive signal RECEIVE_SIG received by the first UWB device 100). For example, the first UWB device 100 may receive the receive signal RECEIVE_SIG in symbol units of the MMRS symbols MMRS1 to MMRS5 transmitted by the second UWB device 200. For example, since the symbol unit of the MMRS symbols MMRS1 to MMRS5 is 8, the first UWB device 100 may receive the receive signal RECEIVE_SIG in units of 8 code symbols.

In this case, since the first UWB device 100 receives a transmit signal in an idle state, idle code symbols IDLE_CSB may be included in the receive signal RECEIVE_SIG. For example, a first receive signal RECEIVE_SIG1 may include eight idle code symbols IDLE_CSB, and a second receive signal RECEIVE_SIG2 may include five idle code symbols IDLE_CSB. The second receive signal RECEIVE_SIG2 may include code symbols included in the first MMRS symbol MMRS1 after the five idle code symbols IDLE_CSB.

In embodiments, the code symbols included in the receive signal RECEIVE_SIG may be expressed based on Equation 2.

$$x [ k ] = \{ \begin{matrix}0 , & k < {k}_{start} \\ s [ k - {k}_{start} ] , & k \geq {k}_{start}\end{matrix} \qquad [ Equation 2 ]$$

Here, kₛₜₐᵣₜ may be the number of idle code symbols. For example, referring to FIG. 5B, kₛₜₐᵣₜ may be 13. x[k] may be the receive signal RECEIVE_SIG reflecting the idle code symbols IDLE_CSB. For example, when k is less than 13, x[k] may be 0. This may represent the idle code symbols IDLE_CSB. In contrast, when k is greater than or equal to 13, x[k] may be s[k−kₛₜₐᵣₜ]. This may represent code symbols included in the MMRS symbols MMRS1 to MMRS5 described with reference to FIG. 5A.

In embodiments, the receive signal RECEIVE_SIG reflecting the influence of the channel 11 may be expressed based on Equation 3.

$$y [ k ] = h \cdot x [ k ] \cdot {e}^{j 2 π f ( k - {k}_{start} )} + n [ k ] \qquad [ Equation 3 ]$$

Here, y[k] may represent the receive signal RECEIVE_SIG reflecting the influence of the channel 11. n[k] may be a white noise component by the channel 11. h may be a complex channel gain of the channel 11.

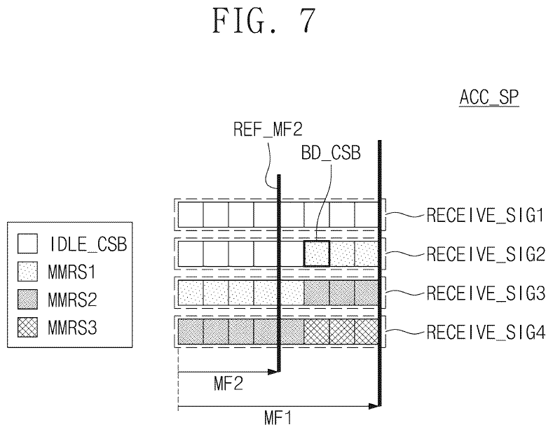

FIGS. 6A and 6B are diagrams for describing an operation of a symbol accumulator.

Referring to FIGS. 1 to 6B, the symbol accumulator 121 may generate an accumulation sample ACC_SP. For example, the symbol accumulator 121 may generate the accumulation sample ACC_SP based on the receive signal RECEIVE_SIG.

In embodiments, the symbol accumulator 121 may accumulate the receive signal RECEIVE_SIG in a specific unit. For example, the symbol accumulator 121 may accumulate the receive signal RECEIVE_SIG in units of four (e.g., four units of 8 code symbols). Referring to FIGS. 6A and 6B, the symbol accumulator 121 may accumulate the receive signal RECEIVE_SIG in units of four, but the scope of the present disclosure is not limited thereto.

In embodiments, the time at which the symbol accumulator 121 accumulates the receive signal RECEIVE_SIG may vary. For example, referring to FIG. 6A, the symbol accumulator 121 may accumulate starting from the first receive signal RECEIVE_SIG1. For example, the symbol accumulator 121 may accumulate starting from the first receive signal RECEIVE_SIG1 in units of four. Therefore, the accumulation sample ACC_SP may be the first to fourth receive signals RECEIVE_SIG1 to RECEIVE_SIG4.

Alternatively, referring to FIG. 6B, the symbol accumulator 121 may accumulate starting from the second receive signal RECEIVE_SIG2. The symbol accumulator 121 may accumulate starting from the second receive signal RECEIVE_SIG2 in units of four. Therefore, the accumulation sample ACC_SP may be the second to fifth receive signals RECEIVE_SIG2 to RECEIVE_SIG5.

In embodiments, the symbol accumulator 121 may store the accumulated accumulation sample ACC_SP in the accumulator buffer ACCBUF. For example, referring to FIG. 6A, the symbol accumulator 121 may store the accumulation sample ACC_SP in which the first to fourth receive signals RECEIVE_SIG1 to RECEIVE_SIG4 are accumulated in the accumulator buffer ACCBUF. Alternatively, referring to FIG. 6B, the symbol accumulator 121 may store the accumulation sample ACC_SP in which the second to fifth receive signals RECEIVE_SIG2 to RECEIVE_SIG5 are accumulated in the accumulator buffer ACCBUF.

In embodiments, the symbol accumulator 121 may accumulate the receive signal RECEIVE_SIG based on Equation 4, and may store the accumulation sample ACC_SP in which the receive signal RECEIVE_SIG is accumulated in a specific unit in the accumulator buffer ACCBUF.

$$AccBuf [ k ] = \{ \begin{matrix}{\sum }_{m = 0}^{{N}_{acc} - {N}_{idle} - 2} [ h \cdot s [ ( m + 1 ) {N}_{samp} - {α}_{start} + k ] \cdot {e}^{j 2 π f ( ( m + 1 ) {N}_{samp} - {α}_{start} + k )} + n [ {mN}_{samp} + k ] ] , \\ for 0 \leq k < {α}_{start} , \\ {\sum }_{m = 0}^{{N}_{acc} - {N}_{idle} - 1} [ h \cdot s [ {mN}_{samp} - {α}_{start} + k ] \cdot {e}^{j 2 π f ( {mN}_{samp} - {α}_{start} + k )} + n [ {mN}_{samp} + k ] ] , \\ for {α}_{start} \leq k < {N}_{samp} ,\end{matrix} \qquad [ Equation 4 ]$$

Here, AccBuf[k] may be a value of the accumulation sample ACC_SP, and N_{acc} may be an accumulation unit in which the symbol accumulator 121 accumulates the receive signal RECEIVE_SIG. For example, referring to FIGS. 6A and 6B, since the symbol accumulator 121 accumulates the receive signal RECEIVE_SIG in units of 4, N_{acc} may be 4.

αₛₜₐᵣₜ may be the number of idle code symbols in a receive signal including code symbols included in the idle code symbols IDLE_CSB and the MMRS symbol. For example, referring to FIGS. 6A and 6B, the receive signal including the code symbols included in the idle code symbols IDLE_CSB and the MMRS symbol may be the second receive signal RECEIVE_SIG2, and the number of idle code symbols in the second receive signal RECEIVE_SIG2 may be 5. Therefore, αₛₜₐᵣₜ may be 5.

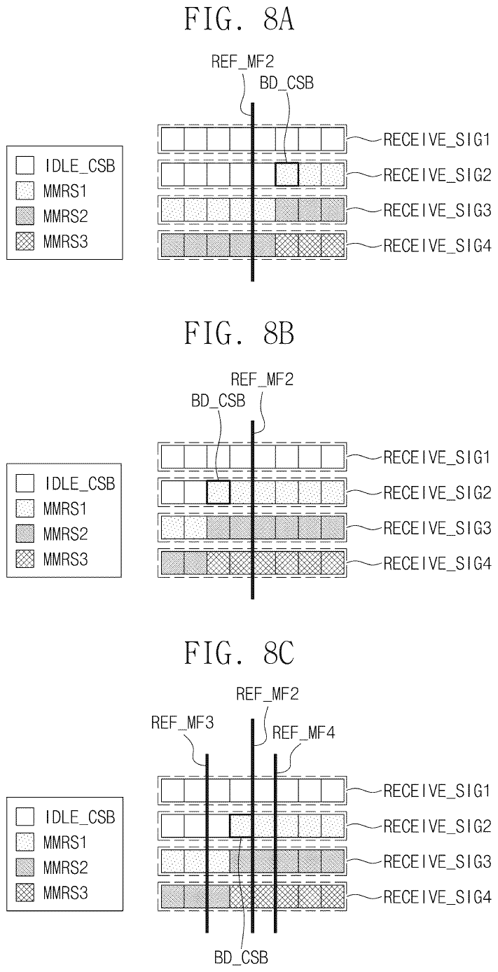

FIG. 7 is a drawing for describing a matched filtering operation of a match filter. Referring to FIGS. 1 to 7, the accumulation sample ACC_SP stored in the accumulator buffer ACCBUF is illustrated.

The match filter 122 may perform matched filtering twice on the accumulation sample ACC_SP. For example, the match filter 122 may perform first matched filtering MF1 on all code symbols included in the accumulation sample ACC_SP, and may perform second matched filtering MF2 on some code symbols (e.g., on a subset of the code symbols) included in the accumulation sample ACC_SP. In this specification, the second matched filtering MF2 is described as being performed on code symbols corresponding to half of the symbol units of the receive signal RECEIVE_SIG. For example, since the symbol units of the first to fourth receive signals RECEIVE_SIG1 to RECEIVE_SIG4 are 8, the second matched filtering MF2 may be performed on 4 code symbols among the code symbols included in the first to fourth receive signals RECEIVE_SIG1 to RECEIVE_SIG4. However, the scope of the present disclosure is not limited thereto.

In embodiments, the match filter 122 may perform the first matched filtering MF1 so as to store in the first circular buffer CIRBUF1 (e.g., store a result of the first matched filtering MF1 in the first circular buffer CIRBUF1), and may perform the second matched filtering MF2 so as to store in the second circular buffer CIRBUF2 (e.g., store a result of the second matched filtering MF2 in the second circular buffer CIRBUF2).

In embodiments, the match filter 122 may perform the first matched filtering based on Equation 5, and may perform the second matched filtering based on Equation 6.

$${CirBuf}_{1} [ l ] = {\sum }_{k = 0}^{{N}_{samp} - 1} AccBuf [ k ] \cdot {s}_{ref}^{*} [ ( k + l ) \% {N}_{samp} ] , \qquad [ Equation 5 ]$$

$$for l = 0 : {N}_{samp} - 1$$

Here, CirBuf₁[l] may be the result of the first matched filtering MF1 stored in the first circular buffer CIRBUF1.

$${CirBuf}_{2} [ l ] = {\sum }_{k = 0}^{\frac{{N}_{samp}}{2} - 1} AccBuf [ k ] \cdot {s}_{ref}^{*} [ ( k + l ) \% {N}_{samp} ] , \qquad [ Equation 6 ]$$

$$for l = 0 : {N}_{samp} - 1$$

Here, CirBuf₂[l] may be the result of the second matched filtering MF2 stored in the second circular buffer CIRBUF2. In embodiments, Equation 6 is expressed as performing the second matched filtering MF2 based on code symbols corresponding to half of the code symbols included in the first to fourth receive signals RECEIVE_SIG1 to RECEIVE_SIG4, but the scope of the present disclosure is not limited thereto.

In embodiments, the symbol boundary detector 123 may estimate a boundary code symbol BD_CSB based on the result of the matched filtering by the match filter 122. For example, the symbol boundary detector 123 may estimate that a sixth code symbol BD_SB among the code symbols included in the second receive signal RECEIVE_SIG2 is on the boundary with the idle code symbol IDLE_CSB based on the result of the first matched filtering MF1.

In embodiments, the symbol boundary detector 123 may estimate the boundary code symbol BD_CSB based on Equation 7. For example, the symbol boundary detector 123 may estimate the boundary code symbol BD_CSB based on the result of the first matched filtering MF1. For example, the symbol boundary detector 123 may estimate the boundary code symbol BD_CSB (e.g., an index value of the boundary code symbol BD_CSB) based on the result of the first matched filtering MF1 stored in the first circular buffer CIRBUF1. According to embodiments, the term “index value” as used herein may refer to a position within the accumulator buffer ACCBUF, but some example embodiments are not limited thereto.

$${\hat{α}}_{start} = arg {max}_{l} ( abs ( {CirBuf}_{1} [ l ] ) ) \qquad [ Equation 7 ]$$

Here, \hat{α}ₛₜₐᵣₜ may be αₛₜₐᵣₜ estimated by the symbol boundary detector 123. For example, the symbol boundary detector 123 may derive \hat{α}ₛₜₐᵣₜ based on Equation 4 to estimate αₛₜₐᵣₜ described in Equation 4. According to embodiments, \hat{α}ₛₜₐᵣₜ may be the index value of the boundary code symbol BD_CSB estimated by the symbol boundary detector 123, and αₛₜₐᵣₜ may be the actual index value of the boundary code symbol BD_CSB.

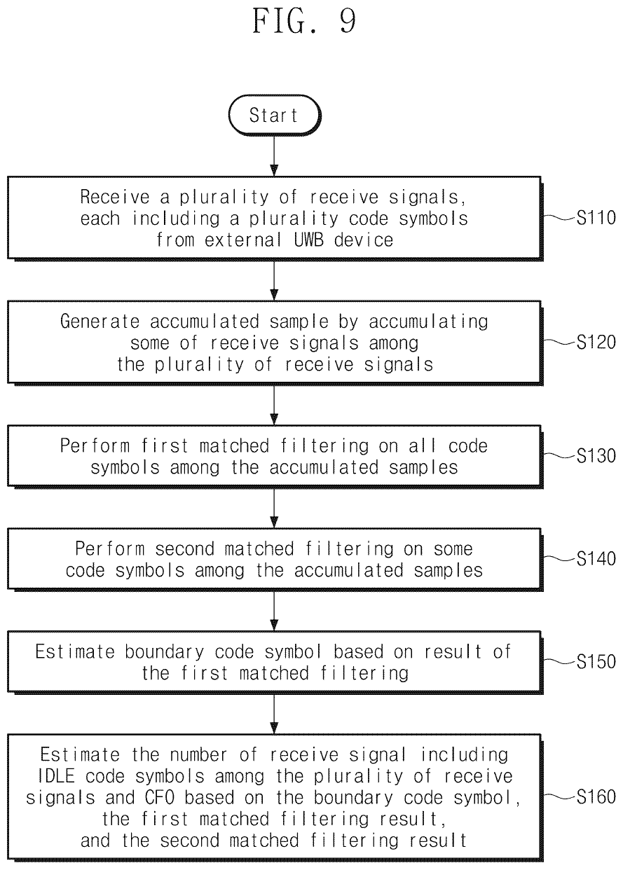

FIGS. 8A, 8B, and 8C are diagrams for describing an operation of an idle CFO estimator.

The idle CFO estimator 124 may estimate N_{idle} and the CFO based on the boundary code symbol BD_CSB estimated by the symbol boundary detector 123. N_{idle} may be the number of receive signals RECEIVE_SIG that include only the idle code symbols IDLE_CSB in the accumulation sample ACC_SP (may also be referred to herein as the first number). For example, referring to FIG. 6A, the first receive signal RECEIVE_SIG1 in the accumulation sample ACC_SP may include only the idle code symbols IDLE_CSB, and N_{idle} may be 1. In contrast, referring to FIG. 6B, there may be no receive signal that includes only the idle code symbols IDLE_CSB in the accumulation sample ACC_SP, and N_{idle} may be 0. The CFO may be a frequency difference between the UWB devices 100 and 200.

In embodiments, FIGS. 8A to 8C illustrate various examples in which the boundary code symbol BD_CSB may exist. Referring to FIG. 8A, a position (e.g., an index value) of the boundary code symbol BD_CSB may be greater than a second matched filtering reference REF_MF2 (e.g., an index value of the second matched filtering reference REF_MF2). Referring to FIG. 8B, the position (e.g., the index value) of the boundary code symbol BD_CSB may be less than the second matched filtering reference REF_MF2 (e.g., the index value of the second matched filtering reference REF_MF2). Referring to FIG. 8C, the position (e.g., the index value) of the boundary code symbol BD_CSB may be the same as (or similar to) the second matched filtering reference REF_MF2 (e.g., the index value of the second matched filtering reference REF_MF2). According to embodiments, the idle CFO estimator 124 may compare the index value of the boundary code symbol BD_CSB to the index value of the second matched filtering reference REF_MF2 to determine whether the index value of the boundary code symbol BD_CSB is greater than, less than or equal to the index value of the second matched filtering reference REF_MF2. Hereinafter, the operation of the idle CFO estimator 124 according to the position of the boundary code symbol BD_CSB will be described. According to embodiments, the below discussion of FIGS. 8A to 8C may refer to operations performed by the idle CFO estimator 124 in response to determining the index value of the boundary code symbol BD_CSB is greater than, less than or equal to the index value of the second matched filtering reference REF_MF2, respectively.

Referring to FIG. 8A first, the position (e.g., the index value) of the boundary code symbol BD_CSB may be greater than the second matched filtering reference REF_MF2 (e.g., the index value of the second matched filtering reference REF_MF2). In this case, the idle CFO estimator 124 may derive the value of the first circular buffer CIRBUF1 with respect to the boundary code symbol BD_CSB based on Equation 8, and may derive the value of the second circular buffer CIRBUF2 based on Equation 9.

$${CirBuf}_{1} [ {\hat{α}}_{start} ] ≅ {\sum }_{k = 0}^{{\hat{α}}_{start} - 1} [ {\sum }_{m = 0}^{{N}_{acc} - {N}_{idle} - 2} h \cdot {e}^{j 2 π f ( ( m + 1 ) {N}_{samp} - {α}_{start} + k )} ] + {\sum }_{k = {\hat{α}}_{start}}^{{N}_{samp} - 1} [ {\sum }_{m = 0}^{{N}_{acc} - {N}_{idle} - 1} h \cdot {e}^{j 2 π f ( {mN}_{samp} - {α}_{start} + k )} ] ≅ [ ( {N}_{acc} - {N}_{idle} ) {N}_{samp} - {\hat{α}}_{start} ] h \cdot {e}^{j 2 π f \frac{( {N}_{acc} - {N}_{idle} ) {N}_{samp} - {\hat{α}}_{start} - 1}{2}} \qquad [ Equation 8 ]$$

Here, CirBuf₁[\hat{α}ₛₜₐᵣₜ] may be a value of the first circular buffer CIRBUF1 with respect to the boundary code symbol BD_CSB (e.g., the index value of boundary code symbol BD_CSB). Based on Equation 8, CirBuf₁[\hat{α}ₛₜₐᵣₜ] may be expressed as a value of N_{idle} and a value of the CFO (f in Equation 8).

$${CirBuf}_{2} [ {\hat{α}}_{start} ] ≅ {\sum }_{k = 0}^{\frac{{N}_{samp}}{2} - 1} [ {\sum }_{m = 0}^{{N}_{acc} - {N}_{idle} - 2} h \cdot {e}^{j 2 π f ( ( m + 1 ) {N}_{samp} - {α}_{start} + k )} ] ≅ ( {N}_{acc} - {N}_{idle} - 1 ) h \cdot {{e}^{j 2 π f ( {N}_{samp} - {α}_{start} )}}^{j 2 π f \frac{( {N}_{acc} - {N}_{idle} - 2 ) {N}_{samp}}{2}} {\sum }_{k = 0}^{\frac{{N}_{samp}}{2} - 1} {e}^{j 2 π fk} ≅ ( {N}_{acc} - {N}_{idle} - 1 ) \frac{{N}_{samp}}{2} h \cdot {e}^{j 2 π f ( {N}_{samp} - {α}_{start} )} {e}^{j 2 π f ( {N}_{acc} - {N}_{idle} - 2 ) {N}_{samp} / 2} {e}^{j 2 π f ( \frac{{N}_{samp}}{2} - 1 ) / 2} ≅ ( {N}_{acc} - {N}_{idle} - 1 ) \frac{{N}_{samp}}{2} h \cdot {e}^{j 2 π f \frac{( {N}_{acc} - {N}_{idle} + \frac{1}{2} ) {N}_{samp} - 2 {\hat{α}}_{start} - 1}{2}} \qquad [ Equation 9 ]$$

Here, CirBuf₂[αₛₜₐᵣₜ] may be a value of the second circular buffer CIRBUF2 with respect to the boundary code symbol BD_CSB. Based on Equation 9, CirBuf₂[\hat{α}ₛₜₐᵣₜ] may be expressed as a value of N_{idle} and a value of the CFO (f in Equation 9).

In embodiments, the idle CFO estimator 124 may estimate N_{idle} and the CFO based on CirBuf₁[\hat{α}ₛₜₐᵣₜ] (may also be referred to herein as the first circular buffer value) derived based on Equation 8 and CirBuf₂[\hat{α}ₛₜₐᵣₜ] (may also be referred to herein as the second circular buffer value) derived based on Equation 9. For example, the estimated N_{idle} may be expressed by Equation 10, and the estimated CFO (f) may be expressed by Equation 11.

$${\hat{N}}_{idle} = arg {min}_{N ∈ [ 0 , {N}_{acc} ]} ( \vert \frac{\vert {CirBuf}_{1} [ {\hat{α}}_{start} ] \vert}{( {N}_{acc} - N ) {N}_{samp} - {\hat{α}}_{start}} - E \vert y [ \cdot ] \vert \vert ) \qquad [ Equation 10 ]$$

$$\hat{f} = \frac{∠ {CirBuf}_{1} [ {\hat{α}}_{start} ] - ∠ {CirBuf}_{2} [ {\hat{α}}_{start} ]}{2 π ( {\hat{α}}_{start} - \frac{1}{2} {N}_{samp} )} \qquad [ Equation 11 ]$$

Next, referring to FIG. 8B, the position (e.g., the index value) of the boundary code symbol BD_CSB may be less than the second matched filtering reference REF_MF2 (e.g., the index value of the second matched filtering reference REF_MF2). In this case, the idle CFO estimator 124 may derive the value of the first circular buffer CIRBUF1 with respect to the boundary code symbol BD_CSB based on Equation 12, and may derive the value of the second circular buffer CIRBUF2 based on Equation 13.

$${CirBuf}_{1} [ {\hat{α}}_{start} ] ≅ [ ( {N}_{acc} - {N}_{idle} ) {N}_{samp} - {\hat{α}}_{start} ] h \cdot {e}^{j 2 π f \frac{( {N}_{acc} - {N}_{idle} ) {N}_{samp} - {\hat{α}}_{start} - 1}{2}} \qquad [ Equation 12 ]$$

Here, CirBuf₁[\hat{α}ₛₜₐᵣₜ] may be a value of the first circular buffer CIRBUF1 with respect to the boundary code symbol BD_CSB. Based on Equation 12, CirBuf₁[\hat{α}ₛₜₐᵣₜ] may be expressed as a value of N_{idle} and a value of the CFO (f in Equation 12).

$${CirBuf}_{2} [ {\hat{a}}_{start} ] ≅ {\sum }_{k = 0}^{{\hat{α}}_{start} - 1} [ {\sum }_{m = 0}^{{N}_{acc} - {N}_{idle} - 2} h \cdot {e}^{j 2 π f ( ( m + 1 ) {N}_{samp} - {α}_{start} + k )} ] + {\sum }_{k = {\hat{α}}_{start}}^{\frac{{N}_{samp}}{2} - 1} [ {\sum }_{m = 0}^{{N}_{acc} - {N}_{idle} - 1} h \cdot {e}^{j 2 π f ( {mN}_{samp} - {α}_{start} + k )} ] ≅ ( {N}_{acc} - {N}_{idle} - 1 ) h \cdot {e}^{j 2 π f ( {N}_{samp} - {α}_{start} )} {e}^{j 2 π f \frac{( {N}_{acc} - {N}_{idle} - 2 ) {N}_{samp}}{2}} {\sum }_{k = 0}^{{\hat{α}}_{start} - 1} {e}^{j 2 π fk} + ( {N}_{acc} - {N}_{idle} ) h \cdot {e}^{j 2 π {fN}_{samp} ( {N}_{acc} - {N}_{idle} - 1 ) / 2} {\sum }_{k = 0}^{\frac{{N}_{samp}}{2} - {\hat{α}}_{start} - 1} {e}^{j 2 π fk} ≅ ( {N}_{acc} - {N}_{idle} - 1 ) \cdot {\hat{α}}_{start} \cdot h \cdot {e}^{j 2 π f ( {N}_{samp} - {α}_{start} )} {e}^{j 2 π f \frac{( {N}_{acc} - {N}_{idle} - 2 ) {N}_{samp}}{2}} {e}^{j 2 π f \frac{( {\hat{α}}_{start} - 1 )}{2}} + ( {N}_{acc} - {N}_{idle} ) ( \frac{{N}_{samp}}{2} - {\hat{α}}_{start} ) h \cdot {e}^{j 2 π f \frac{( \frac{{N}_{samp}}{2} - {\hat{α}}_{start} - 1 )}{2}} {e}^{j 2 π f \frac{{N}_{samp} ( {N}_{acc} - {N}_{idle} - 1 )}{2}} = [ ( {N}_{acc} - {N}_{idle} - 1 ) \cdot {\hat{α}}_{start} + ( {N}_{acc} - {N}_{idle} ) ( \frac{{N}_{samp}}{2} - {\hat{α}}_{start} ) {e}^{- j 2 π f \frac{{N}_{samp}}{2}} ] h \cdot {e}^{j 2 π f \frac{( {N}_{acc} - {N}_{idle} ) {N}_{samp} - {\hat{α}}_{start} - 1}{2}} \qquad [ Equation 13 ]$$

Here, CirBuf₂[\hat{α}ₛₜₐᵣₜ] may be a value of the second circular buffer CIRBUF2 with respect to the boundary code symbol BD_CSB. Based on Equation 13, CirBuf₂[\hat{α}ₛₜₐᵣₜ] may be expressed as a value of N_{idle} and a value of the CFO (f in Equation 13).

In embodiments, the idle CFO estimator 124 may estimate N_{idle} and the CFO based on CirBuf₁[\hat{α}ₛₜₐᵣₜ] (may also be referred to herein as the first circular buffer value) derived based on Equation 12 and CirBuf₂[\hat{α}ₛₜₐᵣₜ] (may also be referred to herein as the second circular buffer value) derived based on Equation 13. For example, the estimated N_{idle} may be expressed by Equation 14, and the estimated CFO (f) may be expressed by Equation 15.

$${\hat{N}}_{idle} = arg {min}_{N ∈ [ 0 , {N}_{acc} ]} ( \vert \frac{\vert {CirBuf}_{1} [ {\hat{α}}_{start} ] \vert}{( {N}_{acc} - N ) {N}_{samp} - {\hat{α}}_{start}} - E \vert y [ \cdot ] \vert \vert ) \qquad [ Equation 14 ]$$

$$\hat{f} = real ( \frac{{CirBuf}_{2} [ {\hat{α}}_{start} ]}{{CirBuf}_{1} [ {\hat{α}}_{start} ]} ) - \frac{( {N}_{acc} - {N}_{idle} - 1 ) \cdot {\hat{α}}_{start}}{( {N}_{acc} - {N}_{idle} ) {N}_{samp} - {\hat{α}}_{start}} \qquad [ Equation 15 ]$$

Finally, referring to FIG. 8C, the position of the boundary code symbol BD_CSB may be the same as (or similar to) the second matched filtering reference REF_MF2. In this case, the idle CFO estimator 124 may not be able to estimate N_{idle} and the CFO based on Equations described with reference to FIGS. 8A and 8B. Therefore, the idle CFO estimator 124 may estimate N_{idle} and the CFO based on matched filtering references REF_MF3 and REF_M4 different from the second matched filtering reference REF_MF2.

For example, when N_{idle} and the CFO are estimated based on the third matched filtering reference REF_MF3, a boundary symbol BD_SB may be greater than the third matched filtering reference REF_M3. In this case, the idle CFO estimator 124 may estimate N_{idle} and the CFO in the manner described through FIG. 8A. In contrast, when N_{idle} and the CFO are estimated based on the fourth matched filtering reference REF_MF4, the boundary symbol BD_SB may be less than the fourth matched filtering reference REF_M4. In this case, the idle CFO estimator 124 may estimate N_{idle} and the CFO in the manner described through FIG. 8B.

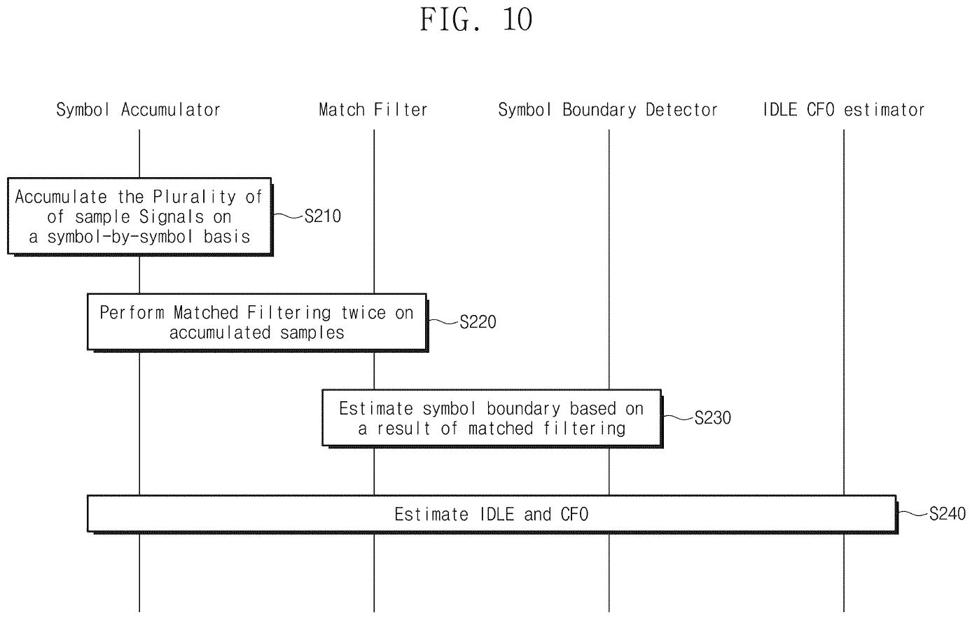

FIG. 9 is a flowchart illustrating an operation method of a UWB device, according to embodiments of the present disclosure.

Referring to FIGS. 1 to 9, in operation S110, the receiver 120 of the first UWB device 100 may receive the plurality of receive signals RECEIVE_SIG each including a plurality of code symbols from an external device (e.g., an external UWB device). For example, the first UWB device 100 may receive a plurality of receive signals each including a plurality of code symbols from the second UWB device 200.

In operation S120, the receiver 120 of the first UWB device 100 may accumulate some of (e.g., a subset of) the receive signals RECEIVE_SIG among the plurality of receive signals to generate an accumulation sample. For example, the receiver 120 of the first UWB device 100 may accumulate the plurality of receive signals in units of a specific number. For example, the receiver 120 of the first UWB device 100 may accumulate the receive signals in units of four.

In operation S130, the receiver 120 of the first UWB device 100 may perform the first matched filtering MF1 on all code symbols among the accumulation samples ACC_SP, and in operation S140, may perform the second matched filtering MF2 on some of (e.g., a subset of) code symbols among the accumulation samples ACC_SP. For example, the receiver 120 of the first UWB device 100 may perform the first matched filtering MF1 on all code symbols among the accumulation samples ACC_SP based on Equation 5 described above. For example, the receiver 120 of the first UWB device 100 may perform the second matched filtering MF2 on some of code symbols among the accumulation samples ACC_SP based on Equation 6 described above.

In operation S150, the receiver 120 of the first UWB device 100 may estimate the boundary code symbol based on the result of the first matched filtering MF1. For example, the receiver 120 of the first UWB device 100 may estimate the boundary code symbol based on Equation 7 described above.

In operation S160, the receiver 120 of the first UWB device 100 may estimate the number of receive signals including the idle code symbol among the receive signals and the CFO based on the boundary code symbol, the result of the first matched filtering MF1, and the result of the second matched filtering MF2. According to embodiments, the first UWB device 100 may determine a reception time of the boundary code symbol using the estimated number of receive signals including the idle code symbol among the receive signals and CFO. According to embodiments, the first UWB device 100 may perform communication with the second UWB device 200 based on the determined reception time of the boundary code symbol. For example, the first UWB device 100 may determine the plurality of MMRS symbols MMRS1 to MMRSm included in the plurality of receive signals RECEIVE_SIG based on the determined reception time of the boundary code symbol. The first UWB device 100 may determine a range to the second UWB device 200 based on the determined plurality of MMRS symbols MMRS1 to MMRSm. According to embodiments, the first UWB device 100 may performing communication with the second UWB device 200 based on the determined range. For example, the first UWB device 100 may (e.g., using the transmitter 110) generate a first signal, process the first signal to perform one or more among modulating, upconverting, filtering, amplifying and/or encrypting on the first signal, and transmit the processed first signal to the second UWB device 200 via one or more antennas. Additionally or alternatively, the first UWB device 100 may receive a second signal from the second UWB device 200 via the one or more antennas, process the second signal to perform one or more among demodulating, downconverting, filtering, amplifying and/or decrypting on the second signal, and perform a further operation(s) based on the processed second signal. For example, the further operation(s) may include one or more of providing the processed second signal to a corresponding application executing on first UWB device 100, storing the processed second signal, sending a response signal to the second UWB device 200 (e.g., based on a processing result of the corresponding application executing on the first UWB device 100), etc.

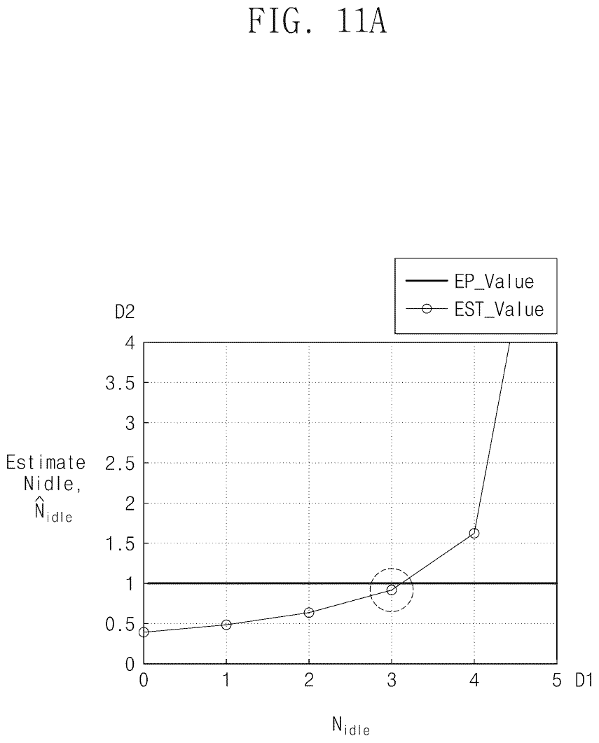

FIG. 10 is a flowchart describing in more detail an operation method of a UWB device, according to embodiments of the present disclosure.

Referring to FIGS. 1 to 10, in operation S210, the symbol accumulator 121 may accumulate the receive signals RECEIVE_SIG1 to RECEIVE_SIG6 in units of symbols. For example, when the second UWB device 200 transmits transmit signals, the symbol accumulator 121 may accumulate the receive signals RECEIVE_SIG1 to RECEIVE_SIG6 in units of symbols. The symbol accumulator 121 may store the accumulated accumulation samples ACC_SP in the accumulator buffer ACCBUF.

In operation S220, the match filter 122 may perform matched filtering twice on the accumulation samples ACC_SP. For example, the match filter 122 may perform matched filtering twice on the accumulation samples ACC_SP stored in the accumulator buffer ACCBUF of the symbol accumulator 121. The match filter 122 may perform the first matched filtering MF1 on all code symbols included in the accumulation samples ACC_SP and may perform the second matched filtering MF2 on some of code symbols included in the accumulation samples ACC_SP.

In operation S230, the symbol boundary detector 123 may estimate the symbol boundary based on the result of the matched filtering. For example, the symbol boundary detector 123 may estimate the boundary symbol BD_SB based on the result of the first matched filtering MF1. For example, the symbol boundary detector 123 may estimate the boundary symbol BD_SB based on the result of the first matched filtering MF1 stored in the first circular buffer CIRBUF1.

In operation S240, the idle CFO estimator 124 may estimate the number of idle samples and the CFO. For example, the idle CFO estimator 124 may estimate the number of idle samples (e.g., N_{idle}) and the CFO (e.g., \hat{f}) based on the boundary symbol BD_SB estimated by the symbol boundary detector 123.

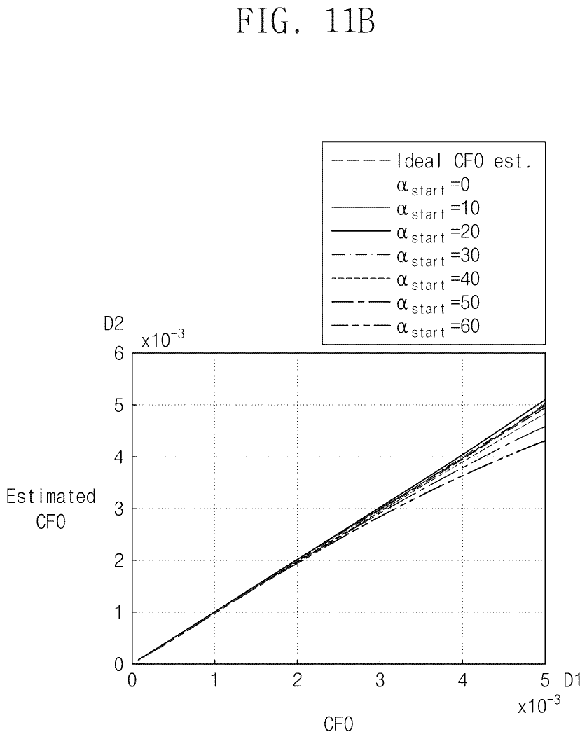

FIGS. 11A and 11B are diagrams for describing the number of idle samples and a CFO.

Referring to FIGS. 1 to 11A, graphs for N_{idle} and \hat{N}_{idle} are illustrated. As described above, N_{idle} may be the number of receive signals RECEIVE_SIG that include only idle code symbols IDLE_CSB in the accumulation sample ACC_SP. \hat{N}_{idle} may be N_{idle} estimated by the idle CFO estimator 124. For convenience of description below, it is described that the number of receive signals RECEIVE_SIG that include only the idle code symbols IDLE_CSB in the accumulation sample ACC_SP is 3, and the idle CFO estimator 124 estimates 3.

A first axis D1 may represent N_{idle}. For example, the first axis D1 may represent the number of receive signals RECEIVE_SIG that include only the idle code symbols IDLE_CSB in the accumulation sample ACC_SP. For example, N_{idle} may increase by 1 along the first axis D1.

A second axis D2 may represent N_{idle}. In this case, the second axis D2 may be expressed by being converted into an expected value EP_Value. For example, when N_{idle} to be estimated is 3, the expected value EP_Value may be 1. However, the scope of the present disclosure is not limited thereto, and when N_{idle} to be estimated is 6, the expected value EP_Value may also be 1.

In embodiments, when N_{idle} to be estimated is 0 to 2, an expected value EST_Value of N_{idle} may be less than 1.

In embodiments, when N_{idle} is 3, the expected value EST_Value of may be 1.

In embodiments, when N_{idle} is 4 or more, the expected value EST_Value of \hat{N}idle may be greater than 1.

In detail, when estimating the number of idle samples using the communication system 10 according to embodiments of the present disclosure, the estimation performance may be improved.

Referring to FIGS. 1 to 11B, graphs for the value of the CFO and the value of the estimated CFO are illustrated. For convenience of description, it is described below that the CFO is estimated based on reference samples REF_SP1 to REF_SP6 whose sample unit is 128.

The first axis D1 may represent the value of CFO. The second axis D2 may represent the value of the estimated CFO.

In embodiments, an estimated value (Ideal CFO est.) of an ideal CFO may be the same as (or similar to) the CFO value. For example, the ratio of the estimated value (Ideal CFO est.) of the ideal CFO to the value of the CFO may be 1.

In embodiments, αₛₜₐᵣₜ may be the number of idle code symbols IDLE_CSB in the receive signal RECEIVE_SIG including code symbols included in the idle code symbols IDLE_CSB and the MMRS symbol. The αₛₜₐᵣₜ number may vary. For example, referring to FIG. 10B, various examples 0, 10, 20, 30, 40, 50, and 60 of αₛₜₐᵣₜ may be depicted on the graph.

In embodiments, when αₛₜₐᵣₜ is 0, the estimated CFO value may be the same as (or similar to) the estimated value (Ideal CFO est.) of the ideal CFO. For example, when αₛₜₐᵣₜ is 0, the ratio of the estimated value of the CFO to the value of the CFO may be 1.

In embodiments, as αₛₜₐᵣₜ is increased, the value of the estimated CFO to the value of the CFO may be less than 1. This may mean that starting CFO estimation performance decreases.

According to embodiments of the present disclosure, when a UWB signal is received in an idle state, the boundary between the idle signal and the UWB signal may be estimated, and the number of idle signals among the received UWB signals may be estimated. When the CFO based on the number of idle signals is estimated, the estimation performance of the CFO may be improved.

Conventional devices and methods for performing communication (and/or ranging) using Ultra Wide Band (UWB) signals are unable to accurately determine a reception time of the UWB signals in a scenario in which a receiving device is in an idle state. This inaccuracy in determining the reception time of the UWB signals results in reduced communication performance (and/or ranging).

However, according to embodiments, improved devices and methods are provided for performing communication (and/or ranging) using UWB signals. For example, the improved devices and methods are able to estimate a number of receive signal including idle code symbols and a Carrier Frequency Offset (CFO). Using this information, the improved devices and methods are able to account for the idle state to more accurately determine a reception time of the UWB signals. Accordingly, the improved devices and methods overcome the deficiencies of the conventional devices and methods to at least improve communication performance (and/or ranging).

According to embodiments, operations described herein as being performed by the communication system 10, the first UWB device 100, the second UWB device 200, the transmitter 110, the receiver 120, the symbol accumulator 121, the match filter 122, the symbol boundary detector 123, and/or the idle CFO estimator 124 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

The above descriptions are detailed examples for carrying out the present disclosure. Embodiments in which a design is changed simply, or which are easily changed, may be included in the present disclosure as well as the examples described above. In addition, technologies that are easily changed and implemented by using the above examples may be included in the present disclosure. Therefore, the scope of the present disclosure should not be limited to the above-described examples and should be defined by not only the claims to be described later, but also those equivalent to the claims of the present disclosure.

What is claimed is:

1. A method of operating an Ultra Wide Band (UWB) device, the method comprising:
receiving a plurality of receive signals from an external device, each of the plurality of receive signals including a plurality of code symbols;
accumulating a subset of receive signals among the plurality of receive signals to generate accumulation samples;
performing first matched filtering on all code symbols among the accumulation samples to obtain a first matched filtering result;
performing second matched filtering on a subset of code symbols among the accumulation samples to obtain a second matched filtering result;
estimating a boundary code symbol based on the first matched filtering result; and
estimating a first number and a Carrier Frequency Offset (CFO) based on the boundary code symbol, the first matched filtering result and the second matched filtering result to obtain an estimated first number and an estimated CFO, the first number being a number of receive signals from among the plurality of receive signals including only idle code symbols.

2. The method of claim 1, wherein the performing of the second matched filtering includes:
determining the subset of code symbols based on a second matched filtering reference.

3. The method of claim 2, wherein the estimating includes:
generating a first circular buffer value based on the boundary code symbol and the first matched filtering result;
generating a second circular buffer value based on the boundary code symbol and the second matched filtering result; and
estimating the first number and the CFO based on the first circular buffer value and the second circular buffer value.

4. The method of claim 3, wherein
an index value of the boundary code symbol is greater than an index value of the second matched filtering reference;
the estimating of the first number and the CFO based on the boundary code symbol, the result of the first matched filtering and the result of the second matched filtering includes:
generating the first circular buffer value based on Equation 1,
generating the second circular buffer value based on Equation 2,
estimating the first number based on Equation 3, and
estimating the CFO based on Equation 4;
the Equation 1 is,
$${CirBuf}_{1} [ {\hat{α}}_{start} ] ≅ [ ( {N}_{acc} - {N}_{idle} ) {N}_{samp} - {\hat{α}}_{start} ] h \cdot {e}^{j 2 π f \frac{( {N}_{acc} - {N}_{idle} ) {N}_{samp} - {\hat{α}}_{start} - 1}{2}} ,$$
where \hat{α}ₛₜₐᵣₜ is the index value of the boundary code symbol, CirBuf₁[\hat{α}ₛₜₐᵣₜ] is the first circular buffer value, N_{idle} is the first number, Nₛₐₘₚ is a number of code symbols included among the plurality of code symbols, N_{acc} is a number of receive signals among the subset of receive signals, f is the CFO and h is a complex channel gain of a channel;
the Equation 2 is,
$${CirBuf}_{2} [ {\hat{α}}_{start} ] ≅ {\sum }_{k = 0}^{\frac{{N}_{samp}}{2} - 1} [ {\sum }_{m = 0}^{{N}_{acc} - {N}_{idle} - 2} h \cdot {e}^{j 2 π f ( ( m + 1 ) {N}_{samp} - {α}_{start} + k )} ] ≅ ( {N}_{acc} - {N}_{idle} - 1 ) h \cdot {e}^{j 2 π f ( {N}_{samp} - {α}_{start} )} {e}^{j 2 π f \frac{( {N}_{acc} - {N}_{idle} - 2 ) {N}_{samp}}{2}} {\sum }_{k = 0}^{\frac{{N}_{samp}}{2} - 1} {e}^{j 2 π fk} ≅ ( {N}_{acc} - {N}_{idle} - 1 ) \frac{{N}_{samp}}{2} h \cdot {e}^{j 2 π f ( {N}_{samp} - {α}_{start} )} {e}^{j 2 π f ( {N}_{acc} - {N}_{idle} - 2 ) {N}_{samp} / 2} {e}^{j 2 π f ( \frac{{N}_{samp}}{2} - 1 ) / 2} ≅ ( {N}_{acc} - {N}_{idle} - 1 ) \frac{{N}_{samp}}{2} h \cdot {e}^{j 2 π f \frac{( {N}_{acc} - {N}_{idle} + \frac{1}{2} ) {N}_{samp} - 2 {\hat{α}}_{start} - 1}{2}} ,$$
where CirBuf₂[\hat{α}ₛₜₐᵣₜ] is the second circular buffer value;
the Equation 3 is,
$${\hat{N}}_{idle} = arg {min}_{N ∈ [ 0 , {N}_{acc} ]} ( \vert \frac{\vert {CirBuf}_{2} [ {\hat{α}}_{start} ] \vert}{( {N}_{acc} - N ) {N}_{samp} - {\hat{α}}_{start}} - E \vert y [ \cdot ] \vert \vert )$$
where \hat{N}_{idle} is the estimated first number, E|y[⋅]| is an arithmetic mean of magnitudes of the receive signals; and
the Equation 4 is,
$$\hat{f} = \frac{∠ {CirBuf}_{2} [ {\hat{α}}_{start} ] - ∠ {CirBuf}_{1} [ {\hat{α}}_{start} ]}{2 π ( {\hat{α}}_{start} - \frac{1}{2} {N}_{samp} )} ,$$
where \hat{f} is the estimated CFO.

5. The method of claim 3, wherein
an index value of the boundary code symbol is less than an index value of the second matched filtering reference;
the estimating of the first number and the CFO based on the boundary code symbol, the first matched filtering result and the second matched filtering result includes:
generating the first circular buffer value based on Equation 5,
generating the second circular buffer value based on Equation 6,
estimating the first number based on Equation 7, and
estimating the CFO based on Equation 8;
the Equation 5 is,
$$C {irBuf}_{1} [ {\hat{α}}_{start} ] ≅ [ \text{} ( {N}_{a c c} - {N}_{idle} ) {N}_{s a m p} - {\hat{α}}_{start} ] h \cdot {e}^{j 2 π f \frac{( {N}_{a c c} - {N}_{i d l e} ) {N}_{s a m p} - {\hat{α}}_{s tart} - 1}{2}} ,$$
where \hat{α}ₛₜₐᵣₜ is the index value of the boundary code symbol, CirBuf₁[\hat{α}ₛₜₐᵣₜ] is the first circular buffer value, N_{idle} is the first number, Nₛₐₘₚ is a number of code symbols included among the plurality of code symbols, N_{acc} is a number of receive signals among the subset of receive signals, f is the CFO and h is a complex channel gain of a channel;
the Equation 6 is,
$${CirBuf}_{2} [ {\hat{α}}_{start} ] ≅ {\sum }_{k = 0}^{{\hat{α}}_{start} - 1} [ {\sum }_{m = 0}^{{N}_{acc} - {N}_{idle} - 2} h \cdot {e}^{j 2 π f ( ( m + 1 ) {N}_{samp} - {α}_{start} + k )} ] + {\sum }_{k = {\hat{α}}_{start}}^{\frac{{N}_{samp}}{2} - 1} [ {\sum }_{m = 0}^{{N}_{acc} - {N}_{idle} - 1} h \cdot {e}^{j 2 π f ( {mN}_{samp} - {α}_{start} + k )} ] ≅ ( {N}_{acc} - {N}_{idle} - 1 ) h \cdot {e}^{j 2 π f ( {N}_{samp} - {α}_{start} )} {e}^{j 2 π f \frac{( {N}_{acc} - {N}_{idle} - 2 ) {N}_{samp}}{2}} {\sum }_{k = 0}^{{\hat{α}}_{start} - 1} {e}^{j 2 π fk} + ( {N}_{acc} - {N}_{idle} ) h \cdot {e}^{\frac{j 2 π {fN}_{samp} ( {N}_{acc} - {N}_{idle} - 1 )}{2}} {\sum }_{k = 0}^{\frac{{N}_{samp}}{2} - {\hat{α}}_{start} - 1} {e}^{j 2 π fk} ≅ ( {N}_{acc} - {N}_{idle} - 1 ) \cdot {\hat{α}}_{start} \cdot h \cdot {e}^{j 2 π f ( {N}_{samp} - {α}_{start} )} {e}^{j 2 π f \frac{( {N}_{acc} - {N}_{idle} - 2 ) {N}_{samp}}{2}} {e}^{j 2 π f \frac{{\hat{α}}_{start} - 1}{2}} + ( {N}_{acc} - {N}_{idle} ) ( \frac{{N}_{samp}}{2} - {\hat{α}}_{start} ) h \cdot {e}^{j 2 π f \frac{( \frac{{N}_{samp}}{2} - {\hat{α}}_{start} - 1 )}{2}} {e}^{j 2 π f \frac{{N}_{samp} ( {N}_{acc} - {N}_{idle} - 1 )}{2}} = [ \text{} ( {N}_{acc} - {N}_{idle} - 1 ) \cdot {\hat{α}}_{start} + ( {N}_{acc} - {N}_{idle} ) ( \frac{{N}_{samp}}{2} - {\hat{α}}_{start} ) {e}^{- j 2 π f \frac{{N}_{samp}}{2}} ] h \cdot {e}^{j 2 π f \frac{( {N}_{acc} - {N}_{idle} ) {N}_{samp} - {\hat{α}}_{start} - 1}{2}} ,$$
where CirBuf₂[\hat{α}ₛₜₐᵣₜ] is the second circular buffer value;
the Equation 7 is,
$${N}^{\hat{}} \_idle = argmin\_ ( N ∈ [ 0 , N\_acc ] ) ( ‖ CirBuf\_ 1 [ {α}^{\hat{}} \_start ] \vert / ( ( N\_acc - N ) N\_samp - {α}^{\hat{}} \_start ) - E \vert y [ \cdot ] ‖ ) ,$$
where N_{idle} is the estimated first number, E|y[⋅]| is an arithmetic mean of magnitudes of the receive signals; and
the Equation 8 is,
$$\hat{f} = real ( \frac{CirBu {f}_{2} [ {\hat{α}}_{s t a r t} ]}{CirBu {f}_{1} [ {\hat{α}}_{s t a r t} ]} ) - \frac{( {N}_{a c c} - {N}_{i d l e} - 1 ) \cdot {\hat{α}}_{s t a r t}}{( {N}_{a c c} - {N}_{i d l e} ) {N}_{s a m p} - {\hat{α}}_{s t a r t}} ,$$
where \hat{f} is the estimated CFO.

6. The method of claim 3, wherein
an index value of the boundary code symbol is equal to an index value of the second matched filtering reference; and
the estimating of the first number and the CFO based on the boundary code symbol, the first matched filtering result and the second matched filtering result includes estimating the first number of receive signals and the CFO based on a third matched filtering reference, an index value of the third matched filtering reference being less than the index value of the second matched filtering reference.

7. The method of claim 3, wherein
an index value of the boundary code symbol is equal to an index value of the second matched filtering reference; and
the estimating of the first number and the CFO based on the boundary code symbol, the first matched filtering result and the second matched filtering result includes estimating the first number and the CFO based on a fourth matched filtering reference, an index value of the fourth matched filtering reference being greater than the index value of the second matched filtering reference.

8. The method of claim 1, wherein the accumulating includes storing the accumulation samples in an accumulator buffer.

9. The method of claim 1, wherein
the performing of the first matched filtering includes storing the first matched filtering result in a first circular buffer; and
the performing of the second matched filtering includes storing the second matched filtering result in a second circular buffer.

10. An Ultra Wide Band (UWB) device comprising:
processing circuitry configured to cause the UWB device to,
receive a plurality of receive signals from an external device, each of the plurality of receive signals including a plurality of code symbols,
accumulate a subset of receive signals among the plurality of receive signals to generate accumulation samples,
perform first matched filtering on all code symbols among the accumulation samples to obtain a first matched filtering result,
perform second matched filtering on a subset of code symbols among the accumulation samples to obtain a second matched filtering result,
estimate a boundary code symbol based on the first matched filtering result, and
estimate a first number and a Carrier Frequency Offset (CFO) based on the boundary code symbol, the first matched filtering result and the second matched filtering result to obtain an estimated first number and an estimated CFO, the first number being a number of receive signals from among the plurality of receive signals including only idle code symbols.

11. The UWB device of claim 10, wherein the processing circuitry is configured to cause the UWB device to determine the subset of code symbols based on a second matched filtering reference.

12. The UWB device of claim 11, wherein the processing circuitry is configured to cause the UWB device to:
generate a first circular buffer value based on the boundary code symbol and the first matched filtering result;
generate a second circular buffer value based on the boundary code symbol and the second matched filtering result; and
estimate the first number and the CFO based on the first circular buffer value and the second circular buffer value.

13. The UWB device of claim 12, wherein
the processing circuitry is configured to cause the UWB device to perform first operations based on an index value the boundary code symbol being greater than an index value of the second matched filtering reference, the first operations including,
generating the first circular buffer value based on Equation 1,
generating the second circular buffer value based on Equation 2,
estimating the first number based on Equation 3, and
estimating the CFO based on Equation 4;
the Equation 1 is,
$${CirBuf}_{1} [ {\hat{α}}_{start} ] ≅ [ \text{} ( {N}_{a c c} - {N}_{idle} ) {N}_{s a m p} - {\hat{α}}_{start} ] h \cdot {e}^{j 2 π f \frac{( {N}_{a c c} - {N}_{i d l e} ) {N}_{s a m p} - {\hat{α}}_{s t a r t} - 1}{2}} ,$$
where \hat{α}ₛₜₐᵣₜ is the index value of the boundary code symbol, CirBuf₁[\hat{α}ₛₜₐᵣₜ] is the first circular buffer value, N_{idle} is the first number, Nₛₐₘₚ is a number of code symbols included among the plurality of code symbols, N_{acc} is a number of receive signals among the subset of receive signals, f is the CFO and h is a complex channel gain of a channel;
the Equation 2 is
$${CirBuf}_{2} [ {\hat{α}}_{start} ] ≅ {\sum }_{k = 0}^{\frac{{N}_{samp}}{2} - 1} [ {\sum }_{m = 0}^{{N}_{acc} - {N}_{idle} - 2} h \cdot {e}^{j 2 π f ( ( m + 1 ) {N}_{samp} - {α}_{start} + k )} ] ≅ ( {N}_{acc} - {N}_{idle} - 1 ) h \cdot {e}^{j 2 π f ( {N}_{samp} - {α}_{start} )} {e}^{j 2 π f \frac{( {N}_{acc} - {N}_{idle} - 2 ) {N}_{samp}}{2}} {\sum }_{k = 0}^{{\hat{α}}_{start} - 1} {e}^{j 2 π fk} ≅ ( {N}_{acc} - {N}_{idle} - 1 ) \frac{{N}_{samp}}{2} h \cdot {e}^{j 2 π f ( {N}_{samp} - {α}_{start} )} {e}^{j 2 π f ( {N}_{acc} - {N}_{idle} - 2 ) {N}_{samp} / 2} {e}^{j 2 π f ( \frac{{N}_{samp}}{2} - 1 ) / 2} ≅ ( {N}_{acc} - {N}_{idle} - 1 ) \frac{{N}_{samp}}{2} h \cdot {e}^{j 2 π f \frac{( {N}_{acc} - {N}_{idle} + \frac{1}{2} ) {N}_{samp} - 2 {\hat{α}}_{start} - 1}{2}} ,$$
where CirBuf₂[\hat{α}ₛₜₐᵣₜ] is the second circular buffer value;
the Equation 3 is,
$${\hat{N}}_{idle} = arg {min}_{N ∈ [ 0 , {N}_{acc} ]} ( \vert \frac{\vert {CirBuf}_{2} [ {\hat{α}}_{start} ] \vert}{( {N}_{acc} - N ) {N}_{samp} - {\hat{α}}_{start}} - E \vert y [ \cdot ] \vert \vert ) ,$$
where \hat{N}_{idle} is the estimated first number, E|y[⋅]| is an arithmetic mean of magnitudes of the receive signals; and
the Equation 4 is,
$$\hat{f} = \frac{∠ {CirBuf}_{2} [ {\hat{α}}_{s t a r t} ] - ∠ {CirBuf}_{1} [ {\hat{α}}_{s t a r t} ]}{2 π ( {\hat{α}}_{s t a r t} - \frac{1}{2} {N}_{samp} )} ,$$
where \hat{f} is the estimated CFO.

14. The UWB device of claim 12, wherein
the processing circuitry is configured to cause the UWB device to perform first operations based on an index value of the boundary code symbol being less than an index value of the second matched filtering reference, the second operations including,
generating the first circular buffer value based on Equation 5,
generating the second circular buffer value based on Equation 6,
estimating the first number based on Equation 7, and
estimating the CFO based on Equation 8;
the Equation 5 is,
$$CirBu {f}_{1} [ {\hat{α}}_{start} ] ≅ [ \text{} ( {N}_{a c c} - {N}_{idle} ) {N}_{samp} - {\hat{α}}_{start} ] h \cdot {e}^{j 2 π f \frac{( {N}_{a c c} - {N}_{i d l e} ) {N}_{s a m p} - {\hat{α}}_{s t art} - 1}{2}} ,$$
where \hat{α}ₛₜₐᵣₜ is the index value of the boundary code symbol, CirBuf₁[\hat{α}ₛₜₐᵣₜ] is the first circular buffer value, N_{idle} is the first number, Nₛₐₘₚ is a number of code symbols included among the plurality of code symbols, N_{acc} is a number of receive signals among the subset of receive signals, f is the CFO and h is a complex channel gain of a channel;
the Equation 6 is,
$$CirBu {f}_{2} [ {\hat{α}}_{start} ] ≅ {\sum }_{k = 0}^{{\hat{α}}_{s t art} - 1} [ {\sum }_{m = 0}^{{N}_{acc} - {N}_{idle} - 2} h \cdot {e}^{j 2 π f ( ( m + 1 ) {N}_{s a m p} - {a}_{s t a r t} + k )} ] + {\sum }_{k = {\hat{α}}_{s t a r t}}^{\frac{{N}_{s a m p}}{2} - 1} [ {\sum }_{m = 0}^{{N}_{a c c} - {N}_{i d l e} - 1} h \cdot {e}^{j 2 π f ( m {N}_{s a m p} - {α}_{s t a r t} + k )} ] ≅ ( {N}_{a c c} - {N}_{i d l e} - 1 ) h \cdot {e}^{j 2 π f ( {N}_{samp} - {α}_{start} )} {e}^{j 2 π f \frac{( {N}_{a c c} - {N}_{i d l e} - 2 ) {N}_{s a m p}}{2}} {\sum }_{k = 0}^{{\hat{α}}_{s t a r t - 1}} {e}^{j 2 π f k} + ( {N}_{a c c} - {N}_{i d l e} ) h \cdot {e}^{\frac{j 2 π f {N}_{s a m p} ( {N}_{a c c} - {N}_{i d l e} - 1 )}{2}} {\sum }_{k = 0}^{\frac{{N}_{s a m p}}{2} - {\hat{α}}_{s t art} - 1} {e}^{j 2 π f k} ≅ ( {N}_{a c c} - {N}_{i d l e} - 1 ) \cdot {\hat{α}}_{start} \cdot h \cdot {e}^{j 2 π f ( {N}_{s a m p} - {α}_{s t a r t} )} {e}^{j 2 π f \frac{( {N}_{a c c} - {N}_{i d l e} - 2 ) {N}_{s a m p}}{2}} {e}^{j 2 π f \frac{( {\hat{α}}_{s t a r t} - 1 )}{2}} + ( {N}_{a c c} - {N}_{i d l e} ) ( \frac{{N}_{s a m p}}{2} - {\hat{α}}_{start} ) h \cdot {e}^{j 2 π f \frac{( \frac{{N}_{s a m p}}{2} - {\hat{α}}_{s t a r t} - 1 )}{2}} {e}^{j 2 π f \frac{{N}_{s a m p} ( {N}_{a c c} - {N}_{i d l e} - 1 )}{2}} = [ \text{} ( {N}_{a c c} - {N}_{i d l e} - 1 ) \cdot {\hat{α}}_{start} + ( {N}_{a c c} - {N}_{i d l e} ) ( \frac{{N}_{s a m p}}{2} - {\hat{α}}_{start} ) {e}^{- j 2 π f \frac{{N}_{samp}}{2}} ] h \cdot {e}^{j 2 π f \frac{( {N}_{acc} - {N}_{i d l e} ) {N}_{samp} - {\hat{α}}_{start} - 1}{2}} ,$$
where CirBuf₂[\hat{α}ₛₜₐᵣₜ] is the second circular buffer value;
the Equation 7 is,
$${\hat{N}}_{i d l e} = arg {min}_{N ∈ [ 0 , {N}_{a c c} ]} ( \vert \frac{\vert {CirBuf}_{1} [ {\hat{α}}_{start} ] \vert}{( {N}_{acc} - N ) {N}_{samp} - {\hat{α}}_{start}} - E \vert y [ \cdot ] \vert \vert ) ,$$
where \hat{N}_{idle} is the estimated first number, E|y[⋅]| is an arithmetic mean of magnitudes of the receive signals; and
the Equation 8 is,
$$\hat{f} = real ( \frac{CirBu {f}_{2} [ {\hat{α}}_{s t a r t} ]}{CirBu {f}_{1} [ {\hat{α}}_{s t a r t} ]} ) - \frac{( {N}_{a c c} - {N}_{i d l e} - 1 ) \cdot {\hat{α}}_{s t a r t}}{( {N}_{a c c} - {N}_{i d l e} ) {N}_{s a m p} - {\hat{α}}_{s t a r t}} ,$$
where \hat{f} is the estimated CFO.

15. The UWB device of claim 12, wherein the processing circuitry is configured to cause the UWB device to estimate the first number and the CFO based on a third matched filtering reference based on an index value of the boundary code symbol being equal to an index value of the second matched filtering reference, an index value of the third matched filtering reference being less than the index value of the second matched filtering reference.

16. The UWB device of claim 12, wherein the processing circuitry is configured to cause the UWB device to estimate the first number and the CFO based on a fourth matched filtering reference based on an index value of the boundary code symbol being equal to an index value of the second matched filtering reference, an index value of the fourth matched filtering reference being greater than the index value of the second matched filtering reference.

17. The UWB device of claim 10, wherein
the UWB includes an accumulator buffer; and
processing circuitry is configured to cause the UWB device to store the accumulation samples in the accumulator buffer.

18. The UWB device of claim 10, wherein
the UWB device includes a first circular buffer and a second circular buffer; and
processing circuitry is configured to cause the UWB device to,
store the first matched filtering result in the first circular buffer, and
store the second matched filtering result in the second circular buffer.

19. An Ultra Wide Band (UWB) communication system comprising:
a transmitter configured to transmit a plurality of transmit signals to an external UWB device, each of the plurality of transmit signals including a plurality of first code symbols; and
processing circuitry configured to cause the UWB communication system to,
receive a plurality of receive signals from the external UWB device, each of the plurality of receive signals including a plurality of second code symbols,
accumulate a subset of receive signals among the plurality of receive signals to generate accumulation samples,
perform first matched filtering on all second code symbols among the accumulation samples to obtain a first matched filtering result,
perform second matched filtering on a subset of second code symbols among the accumulation samples to obtain a second matched filtering result,
estimate a boundary code symbol based on the first matched filtering result, and
estimate a first number and a Carrier Frequency Offset (CFO) based on the boundary code symbol, the first matched filtering result and the second matched filtering result, the first number being a number of receive signals from among the plurality of receive signals including only idle code symbols.

20. The UWB communication system of claim 19, wherein the processing circuitry is configured to cause the UWB communication system to determine the subset of second code symbols based on a second matched filtering reference.
